(19) United States
(12) Patent Application Publication
(10) Pub. No.: US 2002/0186683 A1
(43) Pub. Date: Dec. 12, 2002

(54) Firewall gateway for voice over internet telephony communications

(76) Inventors: Alan Buck, New York, NY (US); Richard St. Pierre, Brooklyn, NY (US)

Correspondence Address: Daniel Basov, Chadbourne & Parke LLP, 30 Rockefeller Plaza, New York, NY, 10112, US

(21) Appl. No.: 09/825,568

(22) Filed: Apr. 2, 2001

(51) Int. Cl. H04L 12/66

(52) U.S. Cl. 370/352; 370/401

(57) ABSTRACT

A method and computerized system for directing voice data transmissions by a gateway server of an Internet telephony service provider between an internal computer system of a registered user and an external device connected to the external network, such as Internet, where the internal computer system is protected by a firewall security system that does not allow transmissions of voice data packets to the internal computer system. The gateway server accepts a request from the internal computer system to initiate exchange of voice data with at least one external device, identifies the user and verifies that sender and recipient are registered with the provider and are currently active and able to exchange voice data. The gateway server also determines whether the internal computer system is allowed to receive voice data packets using a connectionless packet-oriented communication protocol, such as for example UDP, and re-routes all voice data transmissions from the external device through the gateway server, which re-packages voice data transmissions in accordance with a packet and transmission protocol (and format) that is allowed to be sent to the internal computer system, such as for example TCP/IP.

### FIELD OF THE INVENTION

This invention relates to methods and apparatus for providing a secure gateway interface for the firewall-secure networks and more particularly to a secured gateway interface for allowing users behind a firewall to conduct real-time telephony communications over the Internet with one or more third parties located outside the firewall, without violating the firewall security scheme.

### BACKGROUND OF THE INVENTION

The advent and growth of the Internet has brought forth many new types of communications, such as e-mails, live chats, e-bulletin boards, and newsgroups. In addition, the growing popularity and accessibility of the Internet for millions of people has opened doors for new uses of old-fashioned telephony communications, such as allowing individuals to make phone calls over the Internet, send faxes, voice messages, etc.

Generally, telephone calls over the Internet can be made either using a computer, which utilizes special hardware and software to make a phone call, or through a regular telephone, where the analog voice data is digitized, converted into IP packets and transmitted over the Internet (rather than through a Switched Telephone Network) over a large portion of the transmission path. One of the advantages of using the Internet to send and receive voice data is that it provides such communications at a lower price (often at a fixed low cost of subscribing to the services of an Internet Service Provider and an Internet Telephony Service Provider) in comparison with accruing local and long-distance charges using traditional analog switching systems. Thus, a growing number of users utilize their personal computers (PCs) to initiate and/or receive phone calls to and from either the remote PCs or telephone devices of others, both at home and at work.

One complication experienced by many users of the Internet telephony services is that firewall security systems, implemented to protect the computerized networks and individual user PC stations in many business organizations from unauthorized outside access by computer hackers, spam e-mails, downloading of viruses, etc., block and filter out incoming and/or outgoing voice data transmissions.

The term “firewall” generally refers to a barrier that controls and restricts the connections and the flow of data between networks, typically between a corporate network and the Internet. Many different firewall security systems and arrangements are well-known and are currently in use to protect corporate networks and systems. For example, a firewall security system may be implemented using packet-filtering routers, proxy server gateways (i.e., the circuit level gateways, application level gateways and gateways that use stateful inspection security techniques), or possibly by some security programs residing on the user's computer. Many security systems/arrangements examine arriving and outgoing packets of data in accordance with the rules set up by the computer security administrator and block particular types of data transmissions entirely, or selectively block some packets that perform unauthorized actions, such as for example blocking commands containing a PUT command, thereby preventing an unauthorized user from writing files to the server.

When the Internet telephony transmission utilizes a connectionless packet-oriented type of protocol, such as User Datagram Protocol (UDP), as a transport for the voice data packets, the incoming packets (and often the outgoing packets) are blocked by the firewall security, and the telephony communications with third parties outside the secured network are disabled. Thus, there is a need for a system that allows telephony voice communications between computers protected by a firewall and outside third parties, but without compromising the firewall security measures set up to protect against unauthorized data transfers to and from unknown third parties.

When a PC user behind a firewall attempts to place a telephone call over the Internet using a connectionless packet-oriented transfer protocol, such as UDP, or an outside third party intends to establish voice communication with someone behind a firewall using a connectionless transfer protocol, it is often unknown at the connection time whether a two-way transfer of voice data using that protocol is allowed by the firewall security system. Additionally, a firewall may also incorporate NAT (network address translation) that can frustrate a UDP transfer of voice data. Accordingly, there is a need for a system that allows users of the Internet telephony services to determine, prior to placing a call, whether a two-way transfer of voice data using a connectionless packet-based type of transfer protocol over the Internet is possible through one or more firewalls protecting each computer system, i.e., that of a sender and a recipient.

Furthermore, once it is determined that there exists a firewall (with or without NAT) that prevents in-coming or out-going connectionless packet transfers, there is a need for an improved and faster system that would allow users to exchange voice data packets without transferring all packets using a connected, stream-oriented protocol, such as for example TCP/IP, for the whole length of the transfer path.

### SUMMARY OF THE INVENTION

It is therefore one objective of the present invention to provide a method and computerized system for transmitting and receiving voice data over the Internet, when either the sender or the recipient utilizes a computer device that is protected by a firewall security system that does not allow transmissions of voice data using connectionless packet protocol over the firewall or reception of voice data over the Internet from the unknown (non-secure) third parties.

A further object of the present invention is to provide a method and computerized system for transmitting and receiving voice data over the Internet over a secure connection with a gateway/gatekeeper that may be a server of the Internet Telephony Provider (“gateway server”), and which is allowed to exchange either TCP/IP and/or UDP type packets of data with one or more computers protected by a firewall security system, or transmit data through a secure portal of the proxy server protecting the internal computer device or the internal computer network.

Another object of this invention is to allow a gateway server and a user of the Internet telephony services to determine whether the recipient is protected by a firewall and whether a direct two-way voice transmission and communication over the Internet using a connectionless packet protocol with intended recipient are possible through the firewall.

Still another related object of this invention is to provide an Internet voice communication system and method that redirects all incoming and/or outgoing voice data transmissions to and/or from the computer protected by a firewall security through a gateway server whenever the direct voice data transfer using a connectionless packet-oriented type of protocol between the sender and recipient is either fully or partially blocked by the firewall security system.

It is a further object of the invention to provide a system that accomplishes transmission of the voice data redirected through the gateway server by re-packaging the in-coming data into a packet format or using another communication protocol that is allowed to be passed through the firewall, either directly or through a secure portal on the proxy server that maintains the firewall.

The foregoing and other features and advantages of the present invention will become more apparent in light of the following detailed description of exemplary embodiments thereof, as illustrated in the accompanying drawings.

### BRIEF DESCRIPTION OF THE DRAWINGS

FIG. 1 shows a simplified diagram of a general set up of a computerized system for carrying out the method of providing Internet telephony communications in accordance with the invention.

FIG. 2a shows a diagram of a computerized system for carrying out the method of providing Internet telephony communications in accordance with the invention, where the computer system of the internal client that transmits and/or receives voice data over the Internet is protected by a packet-screening firewall router(s).

FIG. 2b shows a diagram of a computerized system for carrying out the method of providing Internet telephony communications in accordance with the invention, where the computer station of one of the parties involved in the communication is on a network of computers that transmit data and communicate over the Internet through one or more proxy servers that provide firewall security for the internal client's computer system.

FIG. 2c shows the logical structure of a firewall proxy server in accordance with the invention, wherein the proxy server provides and administers the firewall security for the internal client's computer network by running proxy services for each different type of Internet application or each different type of packet transmission.

FIG. 2d illustrates a general challenge response mechanism that uses cryptographic encryption to verify a user's identity and authorize access to the gateway server of the Internet Telephony Service Provider for use in accordance with the invention.

FIG. 3a is a print-out of an initial registration HTML page according to the preferred embodiment, which is presented to each subscriber to the Internet telephony services offered by the Internet Telephony Service Provider.

FIG. 3b is a print-out of a “log-in” HTML page according to the preferred embodiment, which is presented to each client performing the initial connection to the gateway server of the Internet Telephony Service Provider prior to sending or receiving a voice transmission from the intended third party over the Internet.

FIG. 4a shows a diagram of a computerized system known in the prior art, where the firewall security system protecting the internal computer system or network blocks or filters out the incoming and/or outgoing UDP packets received over the Internet from an unknown third party.

FIG. 4b shows a diagram of a computerized system and a method according to the invention, allowing the gateway server of the Internet Service Provider to determine whether the firewall security system permits voice data transmissions to and from the internal client's computer system and re-directs the incoming and possibly the outgoing voice data packets through the gateway server of the Internet Telephony Service Provider, which re-packages the voice data packets into the packet format that can be transmitted through the firewall security.

FIG. 5 is a flow-chart showing logical operation of the system according to the invention for the situations when a caller is behind a firewall that does not allow UDP packets to be received, but allows caller to send them, and where a callee can only send UDP packets (shown as case 1), or can send and receive UDP packets (shown as case 4).

FIG. 6 is a flow-chart showing logical operation of the system according to the invention for the situations when a caller is behind a firewall that allows caller to send UDP packets, but does not allow UDP packets to be received, and where a callee can only receive UDP packets (shown as case 2), or callee can neither send nor receive UDP packets (shown as case 3).

FIG. 7 is a flow-chart showing logical operation of the system according to the invention for the situations when a callee can send UDP packets, but can not receive them, and a caller is behind a firewall that does not allow caller to send UDP packets, but allows UDP packets to be received (shown as case 5), or where a caller is not allowed to either send or receive UDP packets (shown as case 9).

FIG. 8 is a flow-chart showing logical operation of the system according to the invention for the situations when neither caller nor callee can send UDP packets but both can received UDP packets (shown as case 6), or where a caller cannot send UDP packets and callee can neither send nor received UDP packets (shown as case 7).

FIG. 9 is a flow-chart showing logical operation of the system according to the invention for the situations when a callee can send and receive UDP packets and a caller is behind a firewall that does not allow UDP packets to be sent and either allows caller to receive UDP packets (shown as case 8) or does not (shown as case 12).

FIG. 10 is a flow-chart showing logical operation of the system according to the invention for the situations when a caller is behind a firewall and can neither send nor receive UDP packets, and a callee can not send UDP packets (shown as case 10) or can neither send nor receive UDP (shown as case 11).

FIG. 11 is a flow-chart showing logical operation of the system according to the invention for the situations when a caller can send and receive UDP packets, and a callee can not receive UDP packets, but can send UDP packets (shown as case 13) or can only send TCP/IP packets (shown as case 15).

FIG. 12 is a flow-chart showing logical operation of the system according to the invention for the situations when a caller can send and receive UDP packets, and a callee can either receive and send UDP packets (shown as case 16) or can only receive UDP packets (shown as case 14).

### DETAILED DESCRIPTION OF THE INVENTION

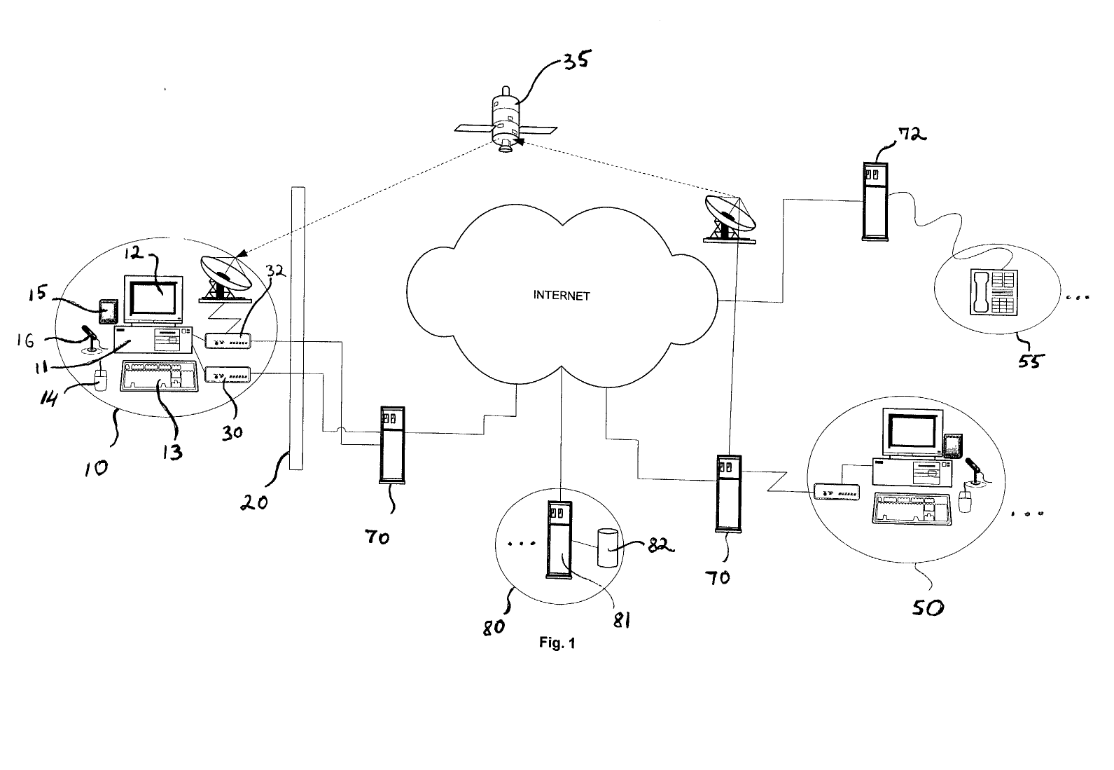

A simplified diagram of a computerized system for transmitting voice data over the Internet in accordance with the invention is shown in FIG. 1. The computer system 10 of the internal client, which is protected by a firewall 20, comprises a CPU 11 with a microprocessor and RAM memory, a display 12, a keyboard 13, a pointing device 14, one or more speakers 15, and a microphone 16 (either built into the computer system, or attached through an external port). The computer system 10 of the internal client may be connected to the Internet either by an external or internal telephone modem 30, a dedicated cable line and a cable modem (not shown), or a wireless modem 32 for connection through the satellite 35, or an Integrated Services Digital Network (ISDN) for digital connection to the Internet. The connection to the Internet for the internal user's computer 10 is typically established through an Internet Service Provider (ISP) 70 to which it may be connected through a public switched telephone network (PSTN). It is understood that other types of connections to the Internet may be utilized to function in accordance with the current invention.

The recipient of the Internet telephony transmissions from the internal user's computer system 10 is at least one external computer system 50, which utilizes a similar set-up and connection to the Internet as the internal user's computer system 10, as described above. In addition, the recipient may also be at least one telephone device 35 (analog or digital), which transmits voice data through the PSTN to the IP voice gateway 72, which may be located at the branch of the telephone company. The IP voice gateway 72 re-packages the incoming voice data into IP packets for transmission over the Internet in accordance with Internet's TCP/IP protocols (or as UDP packets).

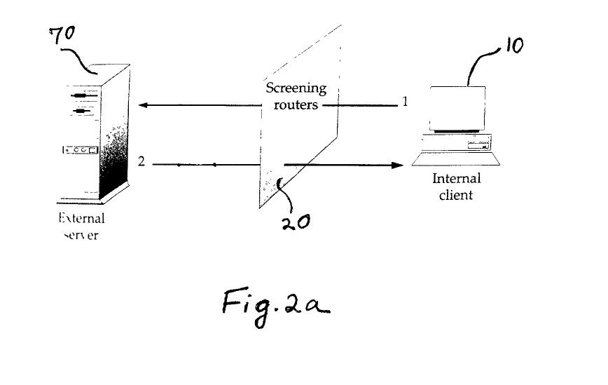

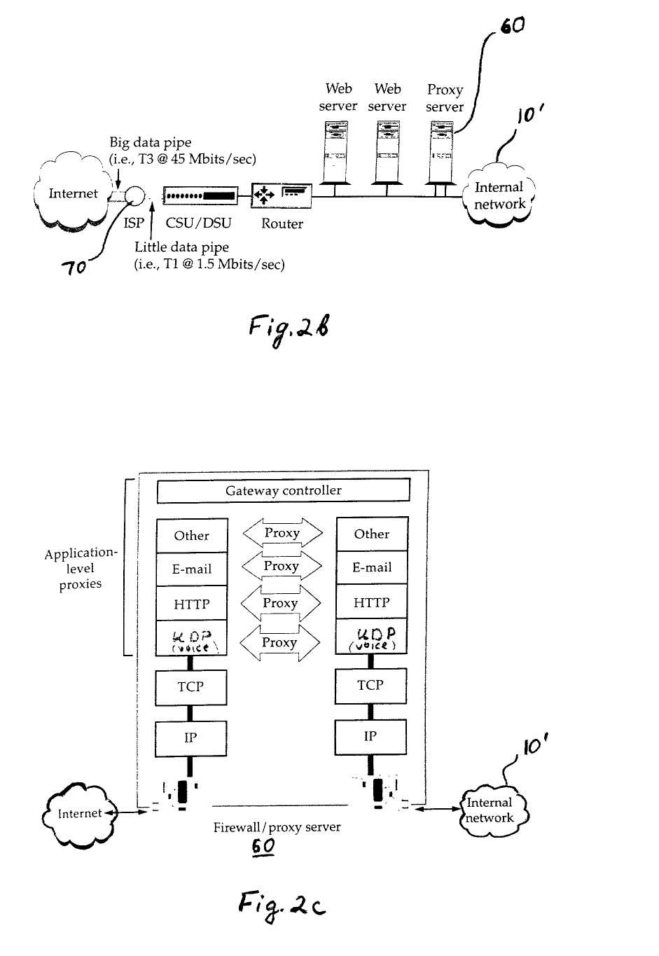

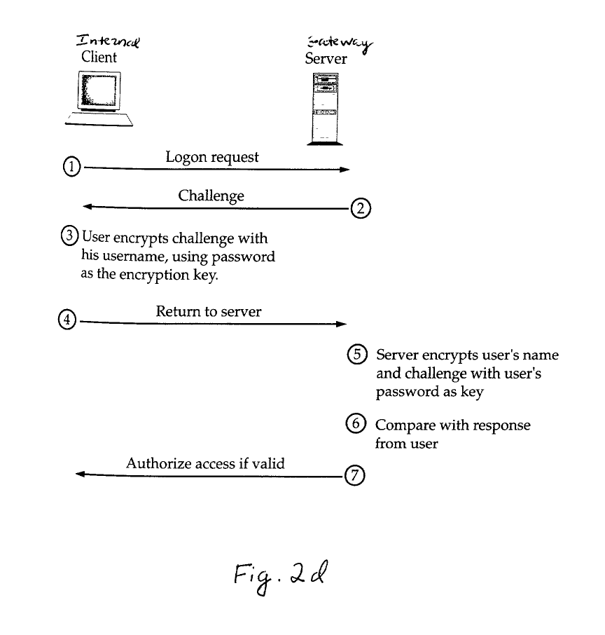

The computer system 10 of the internal client may be a single computer behind a firewall 20, which may be implemented using packet-screening routers, as shown in FIG. 2a, to protect it against unauthorized (non-secure) transmissions over the Internet from external computer(s) 50. More likely, however, the computer system 10 of the internal user is part of an internal corporate network 10′ of computers connected to the Internet through one or more firewall proxy servers 60, as shown in FIG. 2b. The structure of a firewall proxy server, which provides and administers the firewall security for the internal client's computer network 10′ by running proxy services for each different type of Internet application or different type of packet transmission, is shown in FIG. 2c.

In order to receive and transmit voice data over the Internet, the internal client's computer system 10 runs an operating system software, such as for example Windows 2000, or another type of operating system, a Web browser software, such as for example Netscape Navigator™, Microsoft's Internet Explorer™ or another Internet browser program.

As shown in FIGS. 2a and 2b, the internal client's computer is connected to the Internet through an ISP 70, which directs all incoming and outgoing data to the internal network 10′ and the client's computer system. Alternatively, the internal client's computer system or the gateway server of the internal client's network may be an ISP provider itself, and connect directly to the Internet (i.e., have a real IP address on the Internet, which does not need to be processed and re-routed by an ISP). It is also understood that other types of connections to the Internet are currently known or may become popular in the future that can be utilized to connect the internal client's computer (and/or the internal network) to the Internet in accordance with the invention.

In addition to the above-mentioned software, the internal client's computer system also runs a telephony communication software, which may be installed on the client's computer system, or alternatively may reside on the internal network 10′ to which the client's computer system is connected.

### Registration with Internet Service Provider

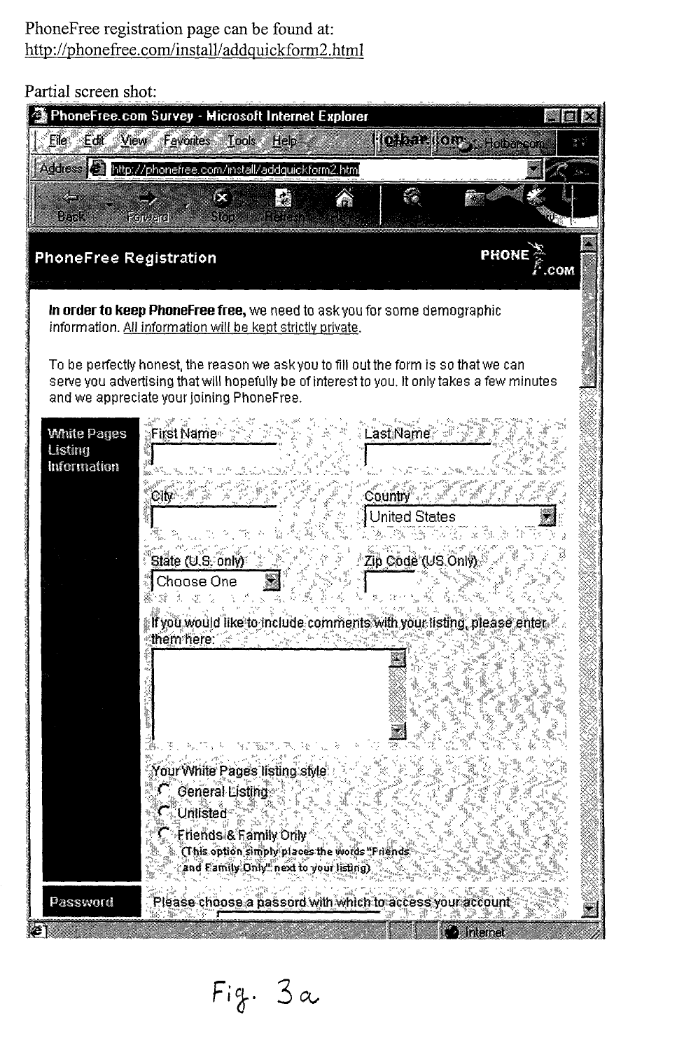

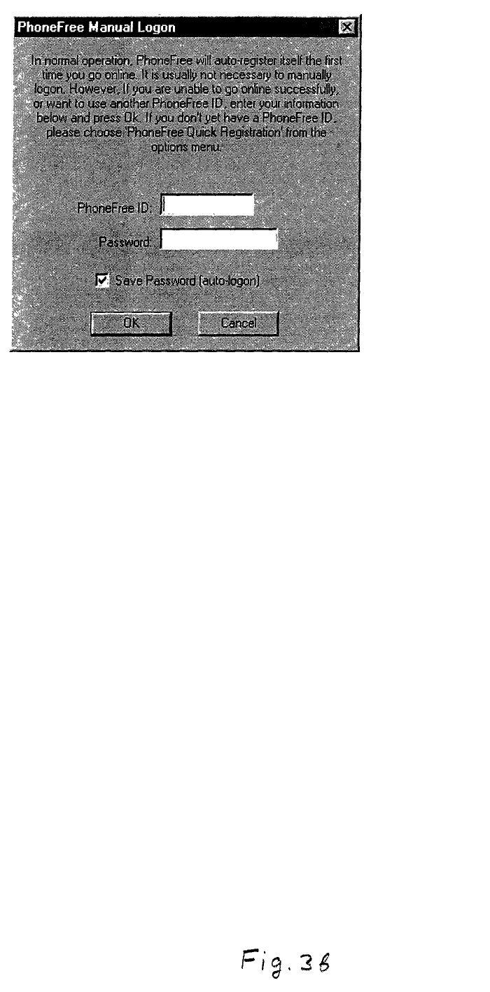

Prior to using the Internet telephony services, a user must register with an Internet Telephony Service Provider by submitting a completed on-line form, which is preferably an HTML page containing user information. The registration process could be made a first mandatory step in the automated process of downloading the telephony communication software from the server of the Internet Telephony Provider to the client's computer. When a user completes this registration step, he/she is assigned a unique user id and password, which are used for initiating telephony communications over the Internet using the downloaded telephony communication software. A print-out of the initial registration HTML screen that is presented to a client according to the preferred embodiment of the invention, requiring the client to input necessary personal information and register for the Internet telephony services of the Internet Telephony Service Provider, is shown in FIG. 3a.

Alternatively, other types of security systems that are commonly utilized on the Internet may also be used. For example, the security information may be stored as a “cookie” on the user's computer system and checked to identify the user during the initiation of a telephony communication.

### Initiating Telephony Connection (“Log-in” by a Registered User)

To initiate telephony communication, a user operating the internal computer system 10 protected by a firewall 20 runs the telephony communication software and enters the “log-in” information, which is transmitted to at least one gateway server 81 of the Internet Telephony Provider 80. A print-out of a log-in HTML screen presented to a client according to the preferred embodiment of the invention to enter necessary security information and initiate telephony communications with the recipient is shown in FIG. 3b.

A challenge/response protocol is preferably implemented on the gateway server 81 for verifying the identity and password information sent by the internal user. A general challenge response mechanism that uses cryptographic encryption to verify a user's identity and authorize access is shown in FIG. 2d. In addition, the gateway server may assign and transmit to the sender an additional password, which is used to secure future voice data transmissions between the internal user's computer and an outside third party.

Once the user is identified, and it is confirmed by the software on the gateway server 81 that the user is registered with the Provider's services, the telephony communication program that runs on the user's computer system periodically transmits the so-called “heart-beat” message over the Internet to the gateway server 81. This “heart-beat” transmission may be sent out as either a TCP/IP data packet, imbedded in an HTML, XTML, or as any other type of data transmission or packet protocol that is allowed to be sent out from the internal computer system or network by the firewall security system. Typically, most firewall security systems allow TCP/IP data packets from the internal computer or network to pass through the firewall. The heart-beat transmission is repeatedly sent to the server 81, identifying the user and informing the server 81 that the user is active and may send or receive telephony voice transmissions. Preferably, the heart-beat transmission also includes the IP address of the user as identification.

As the next step, the sender enters the telephone number (or other type of identifier) of the intended recipient of its telephony communications (i.e. the party to whom it desires to place the call). The telephony communication software that runs on the internal computer system preferably provides a screen or an entry field for the user to enter (using a keyboard, a pointing device or other type of input device) the telephone number of the intended recipient. Furthermore, this function may be incorporated into a browser software, allowing the user to enter recipient's telephone number while in the Internet browser window. The sender may also enter an indication whether the recipient is a computer system or a regular telephone.

This entered information is transmitted to at least one gateway server 81 of the Internet Telephony Provider 80, where it is determined whether the recipient is a regular telephone or a computer system. This determination may be performed by examining a special indicator transmitted by the sender, or by performing a look-up in a database 82 containing information about registered users. The database 82 may be local, remote, centralized or distributed. Thus, the look-up may be performed by multiple gateway servers of one or more Internet Telephony Providers and in multiple databases that contain information about users/subscribers to each Internet Telephony Provider's services.

If it is determined by the computer program running on the gateway server 81 that the recipient is a computer system, rather than a telephone device, it then extracts from the database 82 the IP address, URL or other type of unique Internet address identifier of the recipient's computer system. It also checks in the same database (or an alternative database of logged-in users) whether the recipient is active. As discussed above, the gateway server 81 determines which users are active by receiving periodic heart-beat transmissions from the users that have logged-in and transmitted registration information. A request to send a heart-beat transmission to the gateway server 81 and indicate that the user is still active may also be initiated by the server through periodic polling of all logged-in users.

### Voice Data Transmissions

Once the gateway server 81 determines that both the sender and the recipient(s) are logged-in and ready for the telephony communication, it may signal to each party that they can begin telephony communications. The sender speaks into a microphone 16 that is preferably built into his/her computer system. The analog voice data is then converted to digital form by an analog-to-digital converter, which may be incorporated into the sound card or may be a separate part of the user's computer. Then the digital representation of the voice data may be compressed by the compression software or hardware on the internal client's computer, or somewhere within the internal network in accordance with known compression algorithms. A description of the mathematical compression model used by the G.723.1 Coder, which is utilized in the preferred embodiment to perform the compression of voice data, is included in Appendix 1.

The compressed data is preferably transmitted in accordance with the invention using the H.323 protocol, which is designed to support voice transmission over the Internet. The H.323 protocol, a written specification of which is included in Appendix 2, utilizes a User Datagram Protocol (UDP) or a Real-Time Transport Protocol (RTP) for the transport of voice data. As opposed to a “reliable” type of transmission, or so-called connected, stream-oriented protocol, such as for example TCP/IP, the UDP and RTP are examples of the so-called connectionless packet-oriented transfer protocols, which offer only “best effort” delivery and do not perform error checking and confirmation of transmission prior to processing the received data. The “unreliable” or connectionless type of transmission or protocol is best suited for a fast asynchronous transfer of voice data between parties over the Internet.

Once the digitized voice data is compressed, it may either be sent in a digital form, as an IP packet over an ISDN, a cable modem, or it can again be converted to analog form and sent via a telephone modem and telephone line to an ISP, where the data is digitized and re-packaged as an IP packet for transmission over the Internet.

Upon the receipt of the voice data, the receiving computer 50 separates voice data from any transmission control (i.e., packet control) information and any computer data, decompresses transmitted data from the digital form to the analog form and plays it over the speakers that are either attached or built into the computer system. Then, the recipient initiates a responding voice transmission from its computer by speaking into the microphone that is preferably built into his/her computer system, and the voice data transmission sequence described above is performed in reverse, from the recipient to the sender's computer.

### Determining Whether Voice Transmissions Are Blocked by a Firewall

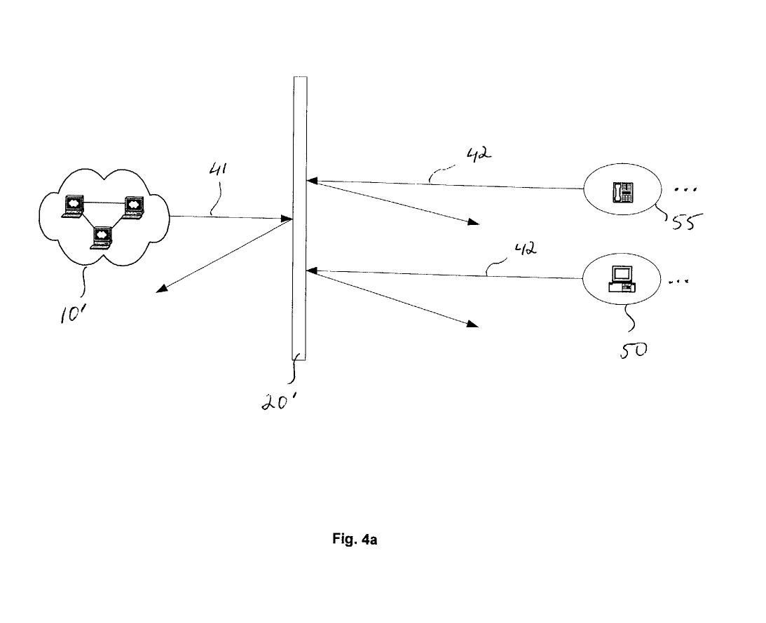

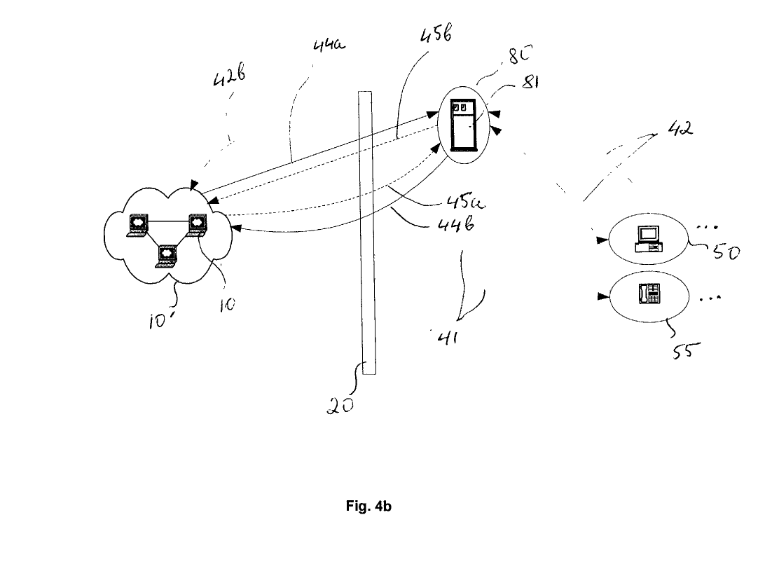

Referring to FIG. 4a, a typical corporate network is protected by a firewall security system 20, which is usually an application level proxy server that blocks the incoming UDP (or RTP) data packets 42 to the internal client's computer network 10′, thereby preventing voice transmissions from unknown third parties outside the firewall, such as the computer system 50 or the telephone device 55, which transmits voice data through an IP voice gateway (not shown). In addition, as also shown in FIG. 4a, the firewall security system may also block the outgoing UDP data packets 41 that are sent from the internal user's computer system or network protected by the firewall. It is also understood that in addition to the internal client's computer system or network being protected by a firewall, the outside computer system 50 (which can also be on a network) may also be protected by its own firewall (not shown).

In accordance with the invention, FIG. 4b illustrates how the gateway server 81 of the Internet Telephony Service Provider 80 is able to determine whether the incoming and/or outgoing voice data packets transmitted to and from the internal computer system are blocked by the firewall security system 20.

As described above, the user operating a computer system, either by itself on the internal computer network 10′ transmits the initial transmission 44a (comprising the log-in information and password) to the gateway server 81 using TCP/IP packet transport protocol, or another type of “reliable” transmission protocol that is allowed to travel through the firewall security system 20. Then the gateway server sends a UDP packet (or another type of packet utilized for the transport of voice data) transmission 45b back to the internal computer system on the internal network 10′. If the transfer is successful, the telephony communication software running on the user's computer sends back a UDP packet transmission 45a to the server. If the return UDP packet(s) 45a is received by the gateway server during a predetermined wait period, it transmits back to the user a “handshake accepted” message 44b as a TCP/IP packet and registers that the firewall security system allows transmission and reception of UDP packets utilized in the preferred embodiment for carrying digitized voice data. Otherwise, when no response is received from the client after a fixed waiting period, the gateway server registers that voice data transmissions are blocked by the firewall security system protecting the client's computer system.

Additionally, in order to determine whether the firewall security system allows any outgoing (rather than incoming) UDP (or RTP) transmissions, the gateway server 81 may send a TCP/IP packet(s) to the user's computer system, requesting a response as a UDP packet(s). If that response is successfully received by the gateway server, it indicates that the firewall security system only blocks the incoming UDP packets, but will allow the outgoing transmissions. Alternatively, the telephony communication program that runs on the user's computer system may be set up to always send a UDP transmission to the gateway server. If this expected transmission is not received by the gateway server, it assumes that the outgoing UDP voice transmissions are blocked by the gateway security system.

The same sequence of steps is also executed by the gateway server 81 to determine whether the remote computer system 50 (which can also be on a network) is also protected by a firewall (not shown), and whether that firewall blocks only the out-going UDP packets, in-coming UDP packets, or both.

### Avoiding Firewall Security Measures that Block Voice Data Transmissions

Once it is determined that the incoming UDP (or RTP) data packets are not allowed to pass through the firewall 20, all voice data transmissions 42 from a remote computer system 50 or a telephone device 55 (packaged as UDP or RTP data packets by an IP voice gateway) are directed through the gateway server 81, as shown in FIG. 4b. The gateway server re-packages the incoming UDP (or RTP) voice data packets 42 as TCP/IP packets 42b that are allowed to be passed to the internal client's computer system 10 by the firewall security system. If, however, it is determined that the outgoing UDP voice data packets are allowed to be transmitted by the firewall security system 20, the UDP (or RTP) voice data packets 41 may be sent directly from the internal client's computer over the Internet to the remote recipient, bypassing the gateway server 81.

On the other hand, if it is determined, as described above, that all UDP (or RTP) packet transfers are blocked by the firewall 20, the telephony communication program that runs on the internal user's computer system may package all digitized voice data as TCP/IP packets, which are sent to the nearest gateway server 81. The server then re-packages the incoming TCP/IP packets as UDP or RTP packets and sends them over the Internet to the recipient. With this strategy, the slow TCP/IP transfer, requiring a receipt acknowledgment and performance of time-consuming error checking, is used only for a short portion of the actual travel path from the internal user's computer to the recipient.

If, for example, the system according to the invention consists of Client 1 that initiates the connection and Client 2, to which Client 1 connects, the gateway server acts as a proxy for either Client 1 or Client 2 if a firewall is detected. When Client 1 detects that it or Caller 2 is behind a firewall, it connects to a gateway server that acts as a proxy server outside the firewall. The server translates UDP packets to TCP packets and/or TCP packets to UDP, depending on what the firewall blocks. It then routes those packets to Client 2. Please note that even though a TCP connection is a bi-directional connection, it is preferable to send packets outside the TCP connection, using UDP, if UDP packets are allowed to be passed through the firewall in at least one direction. For example, Client 1 may be able to send UDP packets out through the firewall, but not receive them. Then Client 1 would use a TCP connection to receive packets, and a separate connection, using UDP, to send them.

Thus, from the point of view of the gateway server, there are sixteen cases to consider when two clients are attempting to talk to one another, as shown in Table 1.

TABLE 1

| Case | Client 1 | Client 2 |
|---|---|---|
| 1 | Send UDP, receive | Send UDP, receive TCP |
| | TCP | |
| 2 * | Send UDP, receive | Send TCP, receive UDP |
| | TCP | |
| 3 | Send UDP, receive | Send TCP receive TCP |
| | TCP | |
| 4 + | Send UDP, receive | Send UDP, receive UDP |
| | TCP | |
| 5 * | Send TCP, receive | Send UDP, receive TCP |
| | UDP | |
| 6 | Send TCP, receive | Send TCP, receive UDP |
| | UDP | |
| 7 | Send TCP, receive | Send TCP receive TCP |
| | UDP | |
| 8 + | Send TCP, receive | Send UDP, receive UDP |
| | UDP | |
| 9 | Send TCP receive TCP | Send UDP, receive TCP |
| 10 | Send TCP receive TCP | Send TCP, receive UDP |
| 11 * | Send TCP receive TCP | Send TCP receive TCP |
| 12 + | Send TCP receive TCP | Send UDP, receive UDP |
| 13 | Send UDP, receive | Send UDP, receive TCP |
| | UDP | |
| 14 | Send UDP, receive | Send TCP, receive UDP |
| | UDP | |
| 15 | Send UDP, receive | Send TCP receive TCP |
| | UDP | |
| 16 ** | Send UDP, receive | Send UDP, receive UDP |
| | UDP | |

+ In the fourth, eighth, and twelfth cases, only one TCP connection is needed (to Client 1).
* In these cases, a gateway server is only needed if the client have problems with NAT.
** Both clients are allowed UDP packet transfers, and a gateway server is only needed if the client has problems with NAT.

From the point of view of view of each the clients, it doesn't matter what the other client would prefer to receive. To each client, the gateway server appears to be a client that happens to be able to receive either TCP or UDP.

In each case shown above, the server must maintain at least two connections—to Client 1 and Client 2. The server may also maintain at least four connections—a TCP and a UDP connection for both Clients. When Client 1 connects to the gateway server, it will pass a message to the server indicating what it would like to send and receive, as well as all the information necessary to connect to Client 2. Client 2, listening on a TCP port, which is commonly known to be such in the industry, receives the message that a connection is requested. Client 2 will, except in cases 4, 8, 12, and 16 above, also establish a connection to the proxy server.

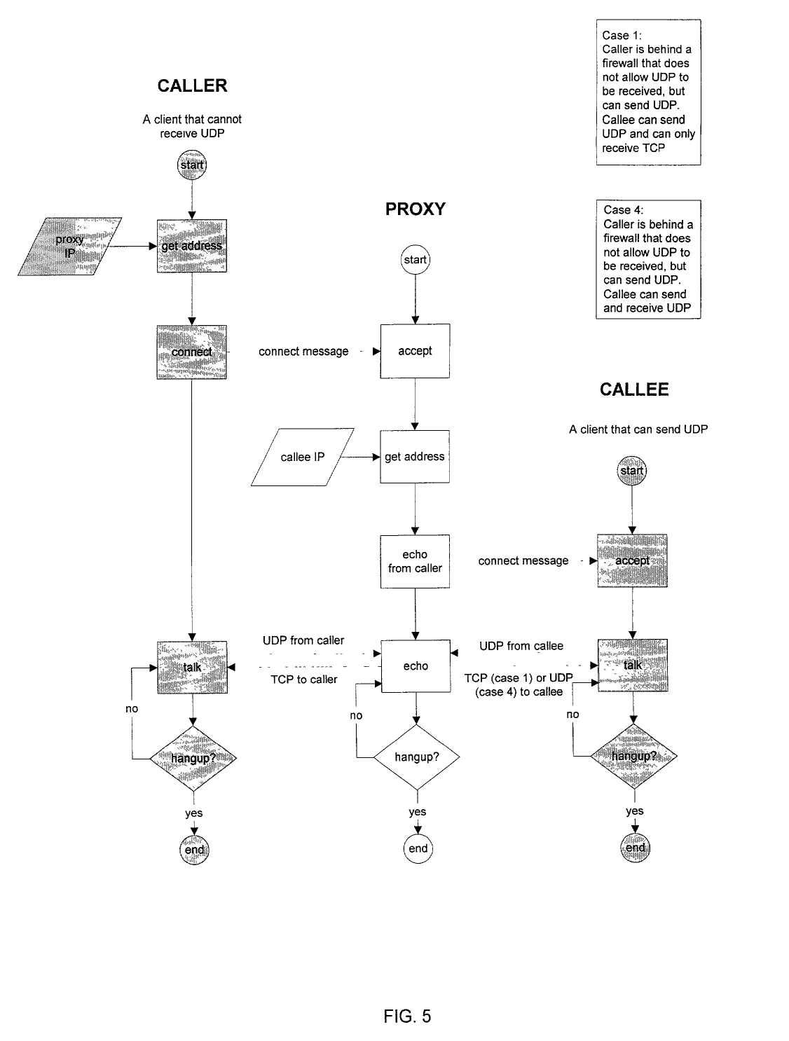

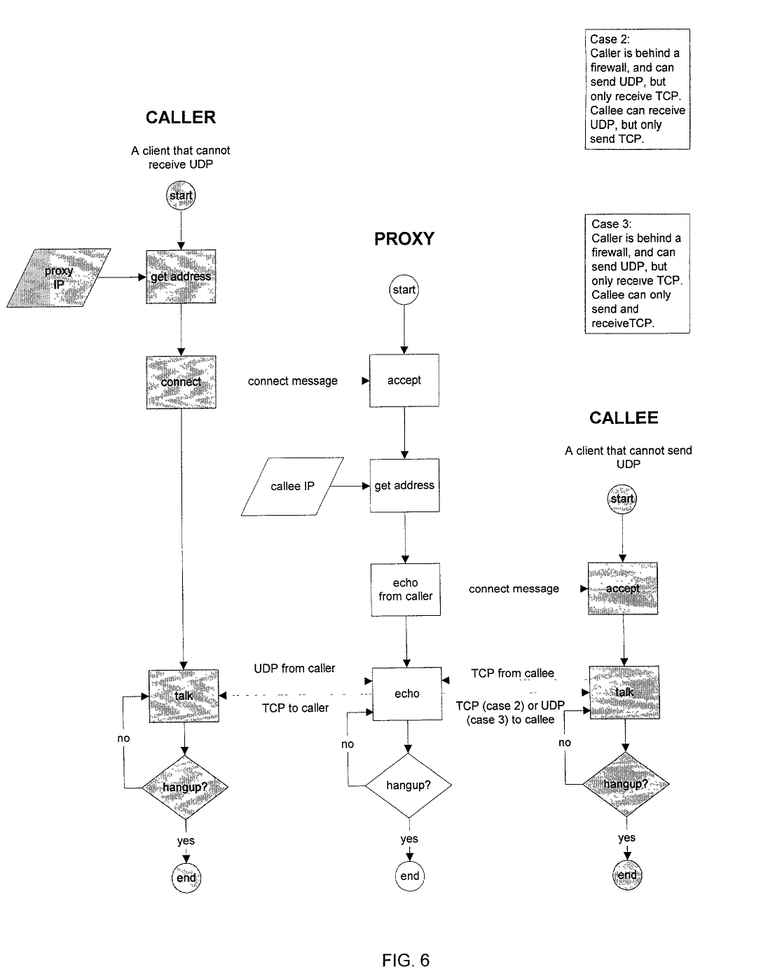

The flow-charts showing logical operation of the system according to the invention for the situations when a caller is behind a firewall and can send, but can not receive UDP packets, and a callee either can or can not send UDP packets, which corresponds to cases #1 and #4 and cases #2 and #3 in Table 1, are illustrated in FIGS. 5 and 6, respectively.

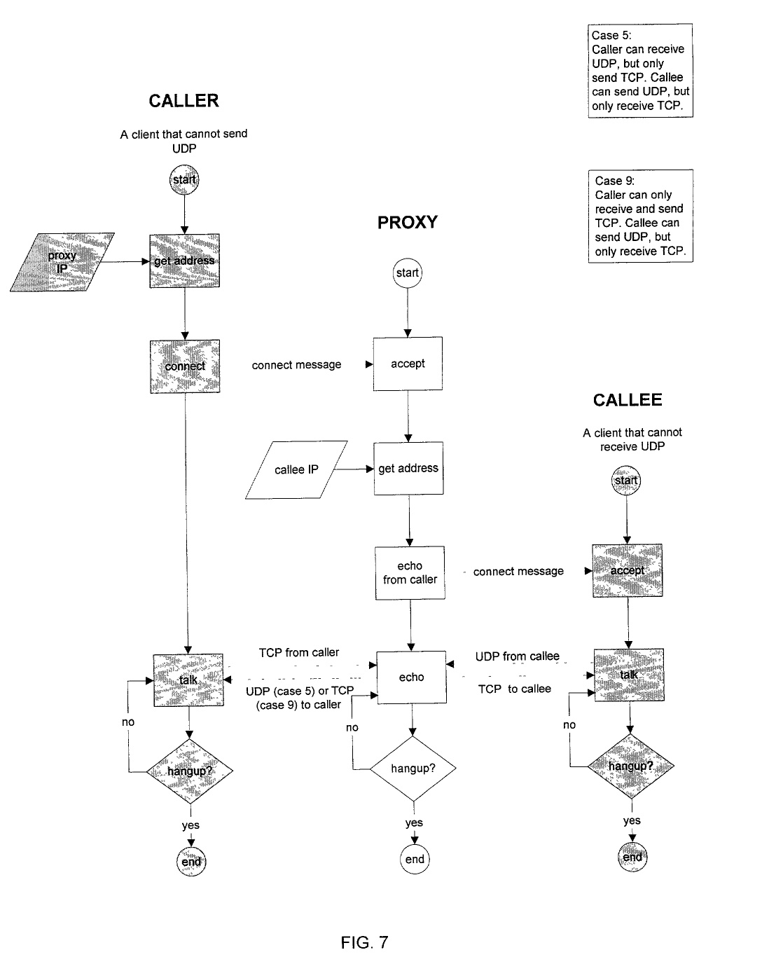

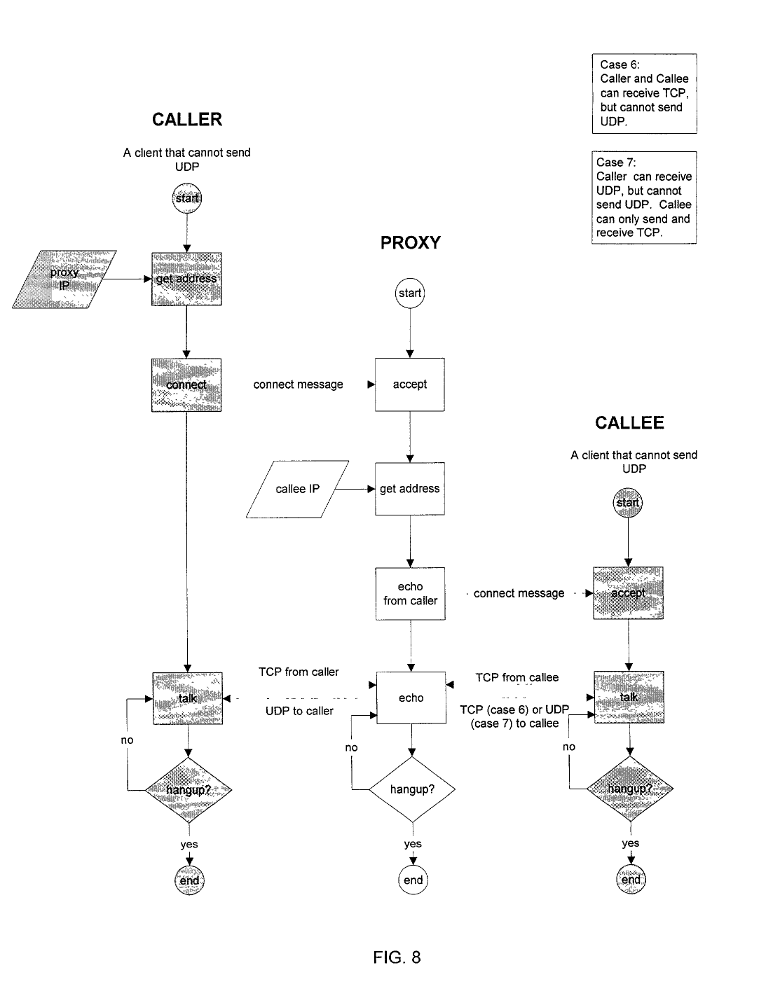

The flow-charts showing logical operation of the system according to the invention for the situations when a caller is behind a firewall that does not allow UDP packets of the caller to be sent, and a callee can not receive or can not send UDP packets, which corresponds to cases #5 and #9 and cases #6 and #7 in Table 1, are shown in FIGS. 7 and 8, respectively.

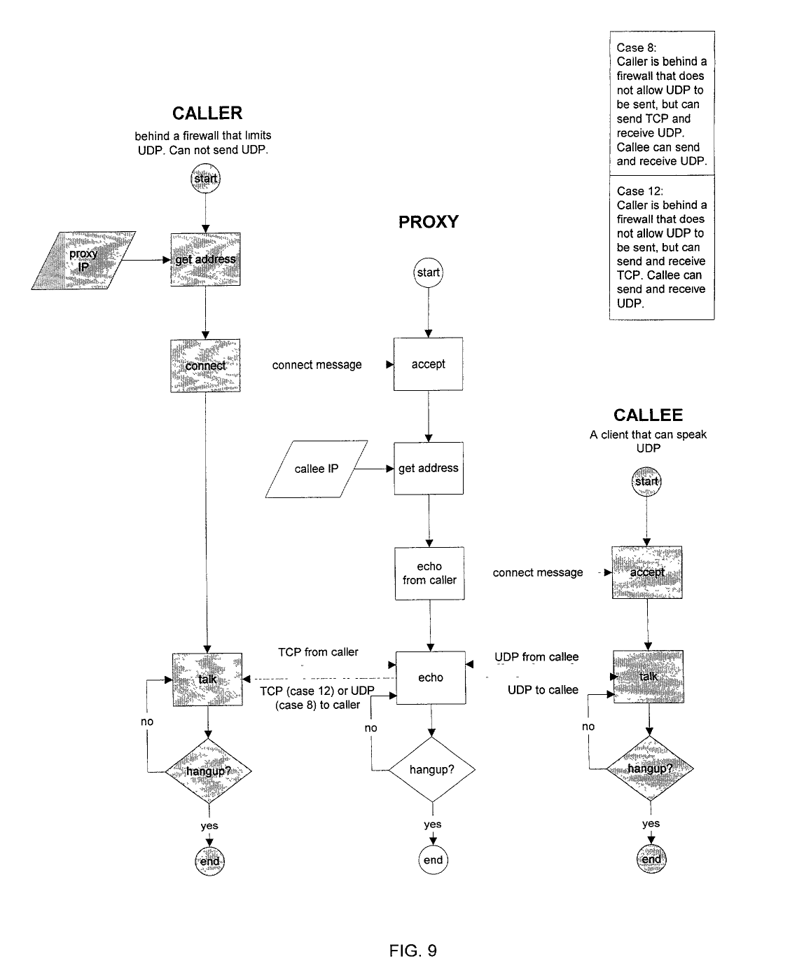

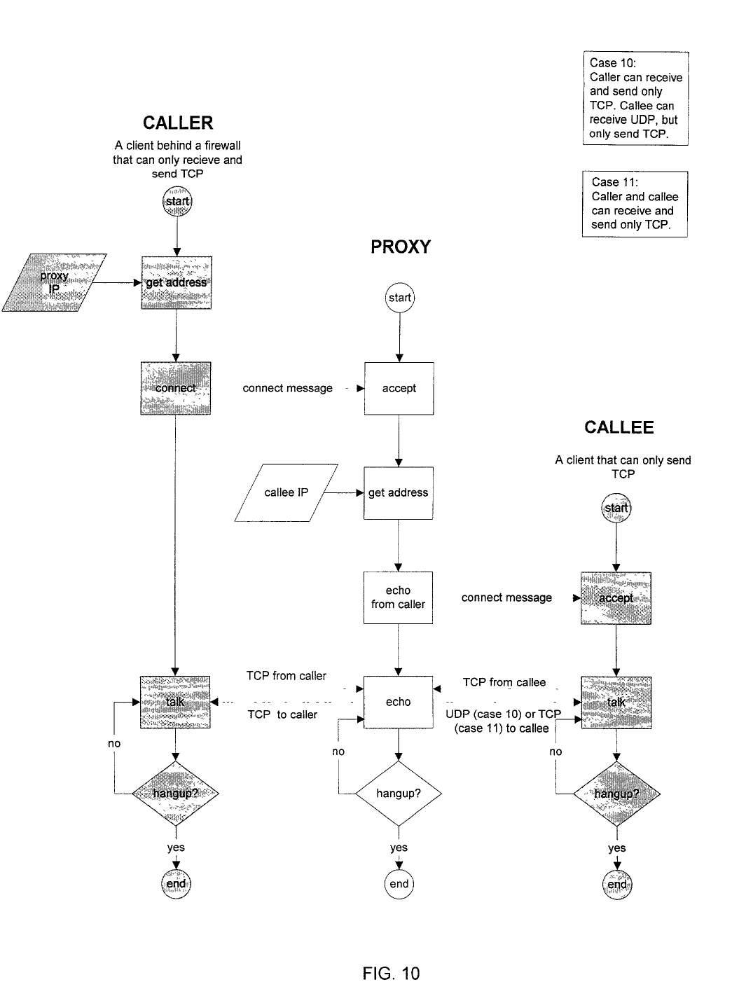

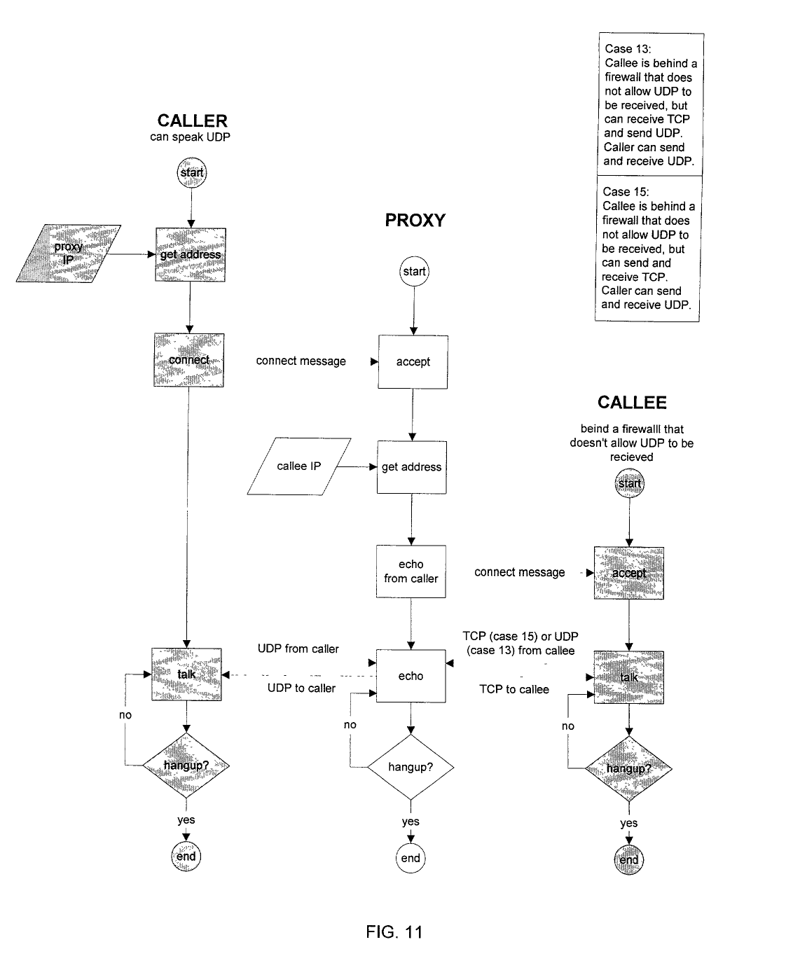

The flow-charts showing logical operation of the system according to the invention for the situations when a caller is behind a firewall that does not allow UDP packets to be sent, and a callee can send and receive UDP packets or can not send UDP packets, which corresponds to cases #8 and #12 and cases #10 and #11 in Table 1, are shown in FIGS. 9 and 10, respectively.

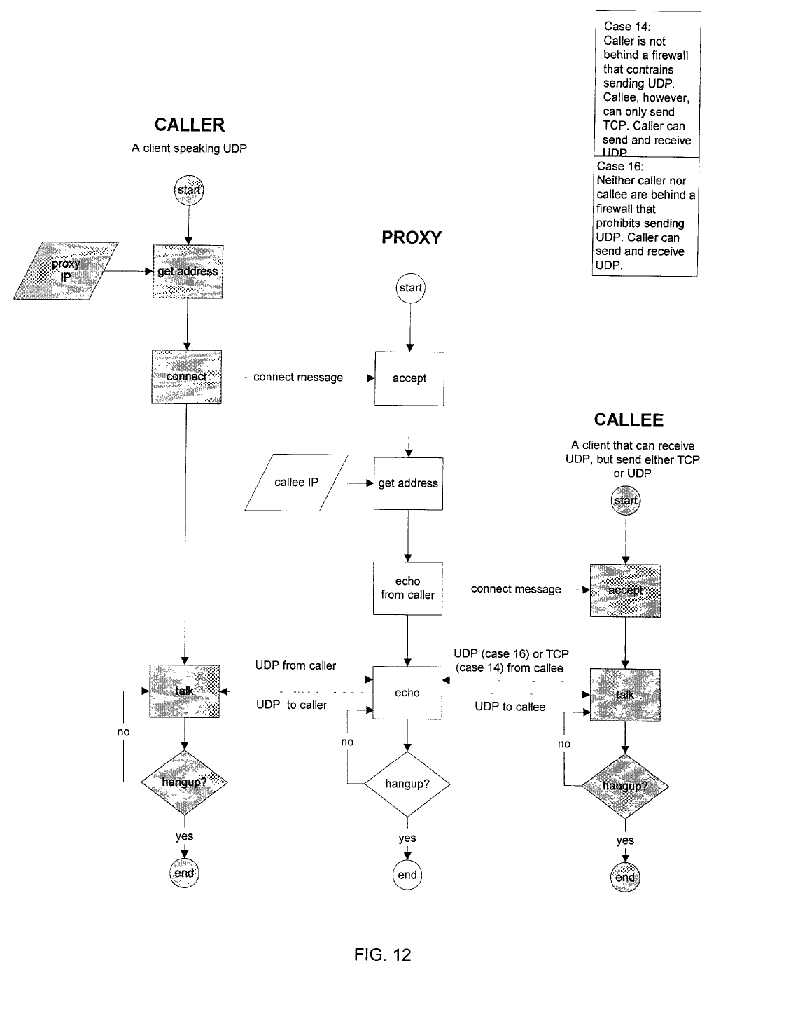

The flow-charts showing logical operation of the system according to the invention for the situations when a caller is behind a firewall that allows it to send and receive UDP packets, corresponding to cases #13 and #15 and cases #14 and #16 in Table 1, are shown in FIGS. 11 and 12.

### Conference Calls

Another important features of a voice over IP in accordance with the invention is the ability to provide and operate conference calling. The method of bypassing the firewall security that is described above also operates with conference calling. Each conference call is made up of a client (Client 1) contacting several other clients (Client 2, Client 3, etc . . . ). Thus, in accordance with the invention, each connection from one client to another client acts as a separate call with it's own connections to the gateway server, if one is needed.

### Communication Through a Secure Portal in a Firewall

In an alternative embodiment of a computerized system for carrying out the method of providing Internet telephony communications in accordance with the invention, the firewall security system may be set up in such a way as to allow either the transmission of voice data though one particular port, or permits UDP (or RTP) data packets to be transferred strictly between the internal computer system(s) and a gateway server 81 of the Internet Telephony Service Provider. If either one of these arrangements is utilized, all voice data transmissions (both incoming and outgoing) are forced to travel through the gateway server of the Internet Telephony Service Provider, which would not need to re-package UDP (or RTP) voice data packets as TCP/IP packets. One shortcoming of this particular embodiment of the computerized system according to the invention is that it might not be acceptable for many security systems, because it opens up a possible security breach to transmissions by hackers, who could either communicate through the open dedicated portal of the firewall proxy server or pose as a gateway server (i.e., fake the IP address of the gateway server).

Although the invention has been described with reference to the specific embodiments, it will be apparent to one skilled in the art that variations and modifications are contemplated within the spirit and scope of the invention. The drawings and descriptions of the specific embodiments are made by way of example only, rather than to limit the scope of the invention, and it is intended to cover within the spirit and scope of the invention all such changes and modifications.

We claim:

1. A method for directing voice data transmissions between at least one internal computer system of at least one registered user, said internal computer system protected by a firewall security system, and at least one external device connected to the external network comprising the steps of:
a) accepting transmission of registration information from said internal computer system by at least one gateway server connected to said external network;
b) processing and storing transmitted registration information in a database connected to said gateway server, together with at least one identifier of said internal computer system;
c) accepting a request from said internal computer system by said gateway server to initiate exchange of voice data with at least one external device connected to the external network;
d) determining whether said external device is active;
e) determining whether said internal computer system is able to receive data packets containing voice data using a connectionless packet-oriented transfer protocol;
f) determining whether said external device is able to receive voice data packets using a connectionless packet-oriented communication protocol over said external network.
g) receiving by said gateway server the voice data packets transmitted from said external device;
h) re-packaging said data packets to the packet type allowed to be transmitted to said internal computer system by the firewall security system; and
i) sending said re-packaged voice data packets that originated at said external device from said gateway server to said internal computer system.

2. The method according to claim 1, further comprising a step of determining whether said internal computer system is active.

3. The method according to claim 2, further comprising a step of determining whether said internal computer system is able to transmit voice data packets using a connectionless packet-oriented communication protocol over said external network.

4. The method according to claim 1, further comprising a step of determining whether said external device is able to transmit voice data packets using a connectionless packet-oriented communication protocol over said external network.

5. The method according to claim 1, wherein said external device is a telephone connected to said external network through at least one IP voice gateway for transmitting at least one voice signal from the telephone as an IP packet over said external network to said internal computer system.

6. The method according to claim 1, wherein said connectionless packet-oriented communication protocol utilized to transmit voice data packets is User Datagram Protocol (UDP).

7. The method according to claim 1, wherein the step of re-packaging voice data packets as data packets of the type allowed to be transmitted to said internal computer system comprises converting UDP data packets to TCP/IP data packets.

8. The method according to claim 1, wherein said firewall security system of said registered user utilizes NAT (network address translation).

9. The method according to claim 1, wherein said external network is the Internet.

10. The method according to claim 9, wherein said internal computer system is part of an internal computer network connected to the Internet through at least one network server.

11. The method according to claim 9, wherein said external device is a computer system connected to the Internet.

12. The method according to claim 9, wherein said external computer system is part of a computer network connected to the Internet through at least one network server.

13. The method according to claim 9, wherein at least one identifier of said internal computer system is its IP address.

14. The method according to claim 9, wherein said external device is connected to the Internet through an Internet Service Provider (ISP).

15. The method according to claim 9, wherein said internal computer system is connected to the Internet through an Internet Service Provider (ISP).

16. The method according to claim 1, wherein the step of accepting transmission of registration information from said internal computer system by at least one gateway server comprises accepting an HTML page containing user information.

17. The method according to claim 1, wherein the step of accepting a request from said internal computer system to initiate exchange of voice data comprises accepting an HTML page containing security information of said user of said internal computer system.

18. The method according to claim 17, wherein said security information comprises a password assigned to said user of said internal computer system.

19. The method according to claim 17, wherein said security information is encrypted.

20. The method according to claim 17, wherein said security information is stored in computer memory of said internal computer system.

21. The method according to claim 1, wherein the step of determining whether said external device is active comprises receiving a transmission by said gateway server from said external device containing data that identifies said user of said external device.

22. The method according to claim 1, further comprising the step of receiving analog voice data through a microphone of said internal computer system of said user and converting said analog voice data to digital format.

23. The method according to claim 22, further comprising the step of compressing said converted digital data representing said analog voice data for transmission to said external device.

24. The method according to claim 23, further comprising the step of combining said compressed digital data representing said analog voice data with additional digital computer data for transmission to said gateway server.

25. The method according to claim 24, wherein said additional digital computer data comprises digital images.

26. The method according to claim 24, wherein said additional digital computer data comprises digital text data.

27. The method according to claim 24, further comprising the step of receiving said combined digital data by said gateway server from said internal computer system.

28. The method according to claim 1, further comprising the step of receiving said re-packaged voice data packets from said gateway server at the internal computer system of said user.

29. The method according to claim 28, wherein said re-packaged voice data packets comprise the analog voice data originated at said external device and a digital text data.

30. The method according to claim 28, wherein said re-packaged voice data packets comprise the analog voice data originated at said external device and a digital image.

31. The method according to claim 28, wherein said re-packaged voice data packets are compressed.

32. The method according to claim 31, further comprising the step of de-compressing said voice data packets and converting them to an analog voice transmission.

33. The method according to claim 1, wherein the step of determining whether said internal computer system is able to receive data packets using a connectionless packet-oriented transfer protocol is accomplished by transmitting a data packet from said gateway server to said internal computer system using a connectionless packet-oriented protocol and waiting for an acknowledgement of the receipt of said transmission for a predetermined time period.

34. The method according to claim 3, wherein the step of determining whether said internal computer system is able to transmit data packets using a connectionless packet-oriented transfer protocol is accomplished by transmitting a request from said gateway server to said internal computer system to send back a reply using a connectionless packet-oriented transfer protocol.

35. The method according to claim 1, wherein the step of determining whether said external device is able to receive data packets using a connectionless packet-oriented transfer protocol is accomplished by transmitting a data packet from said gateway server to said external device using a connectionless packet-oriented protocol and waiting for an acknowledgement of the receipt of said transmission for a predetermined time period.

36. The method according to claim 4, wherein the step of determining whether said external device is able to transmit data packets using a connectionless packet-oriented transfer protocol is accomplished by transmitting a request from said gateway server to said external device to send back a reply using a connectionless packet-oriented transfer protocol.

37. A computer based gateway server for directing voice data transmissions between at least one internal computer system protected by a firewall security system and at least one external device connected to the external network,
wherein said gateway server device executes a computer program that accepts, processes and stores registration information transmitted from said internal computer system in a database connected to said gateway server, together with at least one identifier of said internal computer system;
said computer program of said gateway server being operable to determine whether said internal computer system and said external device are active and whether said internal computer system and said external device are able to receive data packets containing voice data using a connectionless packet-oriented transfer protocol; and
wherein said gateway server device receives voice data packets from said external device, re-packages said data packets to the packet type allowed to be transmitted to said internal computer system by the firewall security system and sends said re-packaged voice data packets to the internal computer system.

38. The device according to claim 37, wherein said computer program of said gateway server is also operable to determine whether said internal computer system and said external device are able to transmit voice data packets using a connectionless packet-oriented communication protocol over said external network.

39. The device according to claim 37, wherein said external device is a telephone connected to said external network through at least one IP voice gateway for transmitting at least one voice signal from the telephone as an IP packet over said external network to said internal computer system.

40. The device according to claim 37, wherein said connectionless packet-oriented communication protocol utilized to transmit voice data packets is User Datagram Protocol (UDP).

41. The device according to claim 37, wherein said gateway server re-packages voice data packets as data packets of the type allowed to be transmitted to said internal computer system by converting them from UDP data packets to TCP/IP data packets.

42. The device according to claim 37, wherein said external network is the Internet.

43. The device according to claim 42, wherein said internal computer system is part of an internal computer network connected to the Internet through at least one network server.

44. The device according to claim 42, wherein said external device is a computer system connected to the Internet.

45. The device according to claim 42, wherein said external computer system is part of a computer network connected to the Internet through at least one network server.

46. The device according to claim 42, wherein at least one identifier of said internal computer system is its IP address.

47. The device according to claim 42, wherein said internal computer system and said external device are connected to the Internet through an Internet Service Provider (ISP).

48. The device according to claim 37, wherein said request from said internal computer system to initiate exchange of voice data is an HTML page containing security information of said user of said internal computer system.

49. The device according to claim 48, wherein said security information comprises a password assigned to said user of said internal computer system.

50. The device according to claim 49, wherein said security information is encrypted.

51. The device according to claim 49, wherein said security information is stored in a computer memory of said internal computer system.

52. The device according to claim 37, wherein said computer program of said gateway server determine whether said internal computer system and said external device are active by receiving at least one transmission from each, each said transmission containing data that identifies the respective user.

53. The device according to claim 37, wherein said re-packaged data packets comprise the analog voice data that originated at said external device and a digital image.

54. The device according to claim 37, wherein said re-packaged data packets comprise the analog voice data that originated at said external device and a digital text data.

55. The device according to claim 37, wherein said re-packaged data packets are compressed.

56. The device according to claim 37, wherein said gateway server determines whether said internal computer system is able to receive data packets using a connectionless packet-oriented transfer protocol by transmitting a data packet from said gateway server to said internal computer system using a connectionless packet-oriented protocol and waiting for an acknowledgement of the receipt of said transmission for a predetermined time period.

57. The device according to claim 37, wherein said gateway server determines whether said external device is able to receive data packets using a connectionless packet-oriented transfer protocol by transmitting a data packet from said gateway server to said external device using a connectionless packet-oriented protocol and waiting for an acknowledgement of the receipt of said transmission for a predetermined time period.

58. The device according to claim 37, wherein said gateway server determines whether said internal computer system is able to transmit data packets using a connectionless packet-oriented transfer protocol by transmitting a request from said gateway server to said internal computer system to send back a reply using a connectionless packet-oriented transfer protocol.

59. The device according to claim 37, wherein said gateway server determines whether said external device is able to transmit data packets using a connectionless packet-oriented transfer protocol by transmitting a request from said gateway server to said external device to send back a reply using a connectionless packet-oriented transfer protocol.

60. The device according to claim 37, wherein said firewall security system is implemented using one or more packet-filtering routers for screening the incoming and outgoing data transmissions between said internal computer system and said external computer network.

61. A method for directing voice data transmissions between at least one internal computer system of at least one registered user that is protected by a firewall security system and at least one external device connected to the external network, said method comprising the steps of:
a) transmitting a registration information from said internal computer system to at least one gateway server connected to said external network;
b) transmitting a request from said internal computer system to said gateway server to initiate exchange of voice data with at least one external device connected to the external network;
c) determining whether said external device is active;
d) determining whether said internal computer system is able to receive data packets containing voice data using a connectionless packet-oriented transfer protocol;
e) determining whether said external device is able to receive voice data packets using a connectionless packet-oriented communication protocol over said external network.
f) transmitting voice data packets from said external device to said gateway server;
g) re-packaging said data packets to the packet type allowed to be transmitted to said internal computer system; and
h) sending said re-packaged voice data packets that originated at said external device from said gateway server to said internal computer system.

62. The method according to claim 60, further comprising a step of determining whether said internal computer system is active.

63. The method according to claim 62, further comprising a step of determining whether said internal computer system is able to transmit voice data packets using a connectionless packet-oriented communication protocol over said external network.

64. The method according to claim 63, further comprising a step of determining whether said external device is able to transmit voice data packets using a connectionless packet-oriented communication protocol over said external network.

65. The method according to claim 61, wherein said external device is a telephone connected to said external network through at least one IP voice gateway for transmitting at least one voice signal from the telephone as an IP packet over said external network to said internal computer system.

66. The method according to claim 61, wherein said connectionless packet-oriented communication protocol utilized to transmit voice data packets is User Datagram Protocol (UDP).

67. The method according to claim 66, wherein the step of re-packaging voice data packets as data packets of the type allowed to be transmitted to said internal computer system comprises converting UDP data packets to TCP/IP data packets.

68. The method according to claim 61, wherein said external network is the Internet.

69. The method according to claim 68, wherein said internal computer system is part of an internal computer network connected to the Internet through at least one network server.

70. The method according to claim 68, wherein said external computer system is part of a computer network connected to the Internet through at least one network server.

71. The method according to claim 68, wherein at least one identifier of said internal computer system is its IP address.

72. The method according to claim 68, wherein said external device and internal computer system are connected to the Internet through at least one Internet Service Provider (ISP).

73. The method according to claim 61, wherein the step of transmitting a registration information from said internal computer system to said at least one gateway server comprises transmitting an HTML page containing user information.

74. The method according to claim 61, wherein the step of transmitting a request from said internal computer system to said gateway server to initiate exchange of voice data with at least one external device comprises transmitting an HTML page containing security information of said user of said internal computer system.

75. The method according to claim 74, wherein said security information comprises a password assigned to said user of said internal computer system.

76. The method according to claim 61, wherein the step of determining whether said external device is active comprises receiving a transmission by said gateway server from said external device containing data that identifies said user of said external device.

77. The method according to claim 61, further comprising the step of receiving analog voice data through a microphone of said internal computer system of said user and converting said analog voice data to digital format.

78. The method according to claim 77, further comprising the step of compressing said converted digital data representing said analog voice data for transmission to said external device.

79. The method according to claim 78, further comprising the step of combining said compressed digital data representing said analog voice data with additional digital computer data for transmission to said gateway server.

80. The method according to claim 79, wherein said additional digital computer data comprises digital images.

81. The method according to claim 79, wherein said additional digital computer data comprises digital text data.

82. The method according to claim 79, further comprising the step of transmitting said combined digital data from said internal computer system to said gateway server.

83. The method according to claim 61, further comprising the step of receiving the re-packaged voice data packets from said gateway server at said internal computer system of said user.

84. The method according to claim 83, wherein said re-packaged voice data packets are compressed.

85. The method according to claim 84, further comprising the step of de-compressing said voice data packets and converting them to analog format.

86. The method according to claim 61, wherein the step of determining whether said internal computer system is able to receive data packets using a connectionless packet-oriented transfer protocol is accomplished by transmitting a data packet from said gateway server to said internal computer system using a connectionless packet-oriented protocol and waiting for an acknowledgement of the receipt of said transmission for a predetermined time period.

87. The method according to claim 63, wherein the step of determining whether said internal computer system is able to transmit data packets using a connectionless packet-oriented transfer protocol is accomplished by transmitting a request from said gateway server to said internal computer system to send back a reply using a connectionless packet-oriented transfer protocol.

88. The method according to claim 61, wherein the step of determining whether said external device is able to receive data packets using a connectionless packet-oriented transfer protocol is accomplished by transmitting a data packet from said gateway server to said external device using a connectionless packet-oriented protocol and waiting for an acknowledgement of the receipt of said transmission for a predetermined time period.

89. The method according to claim 64, wherein the step of determining whether said external device is able to transmit data packets using a connectionless packet-oriented transfer protocol is accomplished by transmitting a request from said gateway server to said external device to send back a reply using a connectionless packet-oriented transfer protocol.
